(19) United States
(12) Patent Application Publication
(10) Pub. No.: US 2026/0080789 A1
(43) Pub. Date: Mar. 19, 2026

(54) METHOD FOR PROVIDING EDUCATIONAL FEEDBACK

(71) Applicant: Rufe Educational Consulting, LLC, Schwenksville, PA (US)

(72) Inventors: Steven Allen Rufe, Schwenksville, PA (US); Griffin Ely Timm, Schwenksville, PA (US)

(21) Appl. No.: 19/232,685

(22) Filed: Jun. 9, 2025

Related U.S. Application Data
(60) Provisional application No. 63/694,639, filed on Sep. 13, 2024.

(51) Int. Cl. G09B 5/02; G06Q 10/0639; G10L 15/22

(52) U.S. Cl. CPC G09B 5/02; G06Q 10/06398; G10L 15/22; G10L 2015/225

(57) ABSTRACT

A method and system capable of providing immediate and useful feedback to an educator using audio input and removing the subjectivity out of teacher evaluations to analyze teaching with a database of selected variables and eliminates relying on student outcome and performance data as the sole metric for the success of the educator and the teaching system.

### BACKGROUND OF THE INVENTION

This invention relates to a method of providing feedback to build trust, improve practice, and provide automated solutions to ensure all students have high quality instruction.

Applicants believe that every educator wants to succeed and deserves feedback to help them be their best. Traditional processes for giving teacher's feedback requires what education is currently lacking: time. To get feedback to a teacher, someone must observe that teacher for a lengthy period of time, write up what they observe (ideally, but not always using a rubric), and set up a time to deliver the feedback to the teacher.

This process is time and labor intensive, may be stressful for the individual educator, and rarely facilitates meaningful outputs or improvement.

It is believed that teachers need better, real-time feedback on their instruction. Applicants believe a non-partial, bias-free, and human-centric approach to providing meaningful and timely feedback is needed.

### SUMMARY OF THE INVENTION

One aspect of the invention provides a method for providing educational feedback comprising providing a computer-implemented system having a database of variables; recording audio input from a subject during teaching; receiving the audio input into a system; selecting variables for analysis; processing the audio input into a transcript; analyzing the transcript based on the variables selected; and creating a report having feedback for the subject.

Another aspect of the invention provides a computer-implemented method of providing educational feedback comprising recording audio input from a subject during teaching for at least 15 minutes; uploading the audio input into a computer-implemented system; selecting variables for analysis; processing the audio input into a transcript; analyzing the transcript based on the variables selected; creating a report having feedback for the subject; deleting the audio input and transcript sending the report; and providing access to a dashboard for comparison of various feedback.

Another aspect of the invention provides A system for providing educational feedback to a user comprising a data storage device storing a set of variables; a recording device to record audio input during teaching, the audio input being uploaded to the system; a transcript created from the audio input; an input mechanism to choose at least one variable from the set of variables; a processor to analyze the transcript in view of the chosen variables and provide an analysis; a report having feedback generated from the analysis; and a communication mechanism to provide the report to the user.

### BRIEF DESCRIPTION OF DRAWINGS

FIG. 1 shows a flow diagram of one embodiment of the invention.

FIG. 2 shows a flow diagram of an example of one embodiment of the invention.

### DETAILED DESCRIPTION OF THE INVENTION

The invention aims to take the subjectivity out of teacher evaluations, with the goal of moving on from simply relying on student outcome and performance data as the sole metric for success of an educator. The invention preferably includes a computer-implemented system, such as a computer, handheld device, tablet, smartphone, or any other electronic device. The system may also be a cloud-based system. The system or program has a database of variables and records or links to a recording made by a user to record audio input from a subject or user during teaching. The user may be the teacher or an administrator or other person seeking feedback or other information on the subject's performance. The subject is preferably a teacher or educator, but can be any person seeking feedback on his or her teaching or lecturing ability. The audio input may be a video or audio recording in any format. The recording may be done by a handheld device, video recorder, audio recorder, computer, or any other recording device. Preferably, the recording is at least 15 minutes, but the length needed depends on the feedback desired and chosen variables.

The system receives the audio input through loading it into the system or directly recording it. The user may select the variables for analysis at any time for the system to determine the type of feedback desired. The variable may be a number of questions, number of statements, number of yes and no responses, number of non-verbal responses, number of verbal responses, number of times a word is used, number of praises, number of criticisms, number of opportunities to respond, number of choices offered with a task, number of responses during a period of time, and/or number of words during a period of time. The variable may be anything that the subject provides to students or other audience and the responses received from the students or other audience. The list of variables is virtually unlimited and customizable.

In one example, the variables are related to academic instruction and are inputted into the systems as follows:

```
Questioning
  - # of questions asked
  - Level of Bloom's Taxonomy for questions
Opportunities to Respond (OTRs)
  - # of OTRs
  - # of OTRs per minute
    • # of verbal OTRs
      - # of yes/no responses
      - # of higher order thinking responses
    • # of non-verbal OTRs
      - Different non-verbal OTRs used
```

In another example, the variables are related to non-academic instructions and are inputted into the system as follows:

School Climate
- Relationships

| | |
|---|---|
| • | # of times a student's name is used |
| • | # of unique students called by name |

- School-Wide Connections

| | |
|---|---|
| • | # of times school-wide norms (i.e., safe, respectful, responsible) or skills (i.e., |
| | being safe and walking) are referenced |

- Positive School Climate

| | |
|---|---|
| • | General praise to corrections ratio |
| | - # of academic praises |
| | - # of behavioral praises |
| | - Praise: |
| | - # of specific and non-specific praises |
| | - # academic, # behavioral |
| | - % behavior, % academic |
| | - Corrections: |
| | - # of specific and non-specific corrections |
| | - # academic, # behavioral |
| | - % behavior, % academic |

- Trauma-Informed Practices

| | |
|---|---|
| • | # of students shames |
| • | # of times staff engaged in a power struggle |

The system uses Bloom's taxonomy, a framework for learning, teaching and educational achievement. In many cases, the framework consists of six major categories: Knowledge, comprehension, application, analysis, synthesis, and evaluation. This framework is often depicted in the form of a pyramid, where each stage lies on a continuum. The categories after Knowledge may be presented as “skills and abilities,” with the understanding that knowledge is the necessary precondition for putting these skills and abilities into practice. It is recognized that students move up through each level of the pyramid in Bloom's taxonomy, starting from very basic learning, to acquire deeper knowledge on a subject, with each level crucial to the development of the next.

Some revised taxonomies include verts and gerunds to label categories and subcategories, rather than nouns, such as create, evaluate, analyze, apply, understand, and remember. Create may mean to produce new or original work, evaluate may man to justify a stand or decision, analyze may mean drawing connections among ideas, apply may mean to use information in new situations, understand may mean to explain ideas or concepts, and remember may mean to recall facts and basic concepts.

The system processes the audio input into a transcript. The system may harness the power of transcription abilities and speech to text, Artificial Intelligence (“AI”), and large language models, and reporting automations to take user audio input and analyze it on specific variables to provide an output report. In addition, AI may be implemented into the system and tailored to the specific uses.

The system analyzes the transcript based on the variables selected and creates a report having feedback for the subject. The report can be in any form-oral or written and provided on paper or electronically.

In one example, the system counts the number of statements made in a certain category and generates data to provide the number in a readable report.

The system provides context-specific output at the individual, school, and/or district-level(s) to help implement evidence-based practices.

Users Often want Feedback to be:
Regular—A one point in time evaluation a few times a year is not usually enough; users may get regular, ongoing feedback to improve their practice.
Unique—Users may receive individualized feedback; real-time results may be specifically-catered to the user.
Fair—Walkthroughs and observations may include a human element; bias is able to be removed from the process through automation.
Easy—the information may be efficient, modern, and automated technology-based solutions that are quick and simple.

The feedback may be immediate or given at a future time. In embodiment, the system provided immediate corrective feedback to the user and measures improvement of the teaching over time. Feedback may be communicated verbally, or via email, printed, document, dashboard or another means.

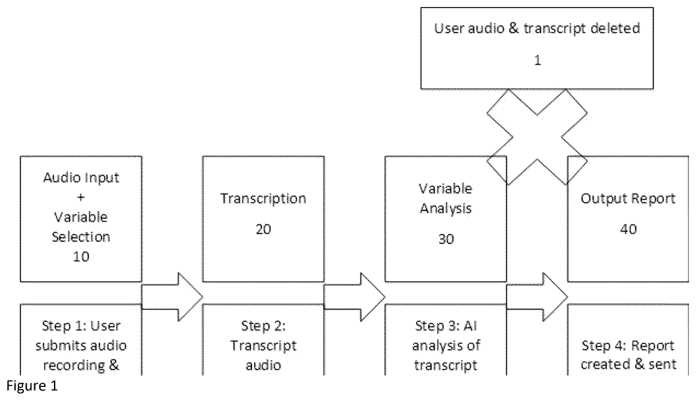

FIG. 1 is a flow diagram of one embodiment of the invention.

The audio input and any written or digital transcripts may be deleted after given to the user to maintain privacy of the subject or teacher. Several reports may also be combined to establish a learning report of how the teacher has progressed in his or her teaching. The system may also have a dashboard for the subject to view variable feedback and track data over time.

The system may also be used for multiple subjects. The system may record audio input from several subjects in a category, anonymize the subjects, and combine the feedback from each subject into the report. In one embodiment, the category may be a grade level and the subjects may be teachers in the same grade.

In one embodiment, the system receives audio input and variable selection 10, processes a transcription 20, performs a variable analysis 30, and provides an output report 40. The user audio and transcript may then be deleted, as show in box 1.

In one example, the system records audio input from a subject during teaching for at least 15 minutes, uploads the audio input into the system, and selects variables for analysis, as shown in box 50. The system processes the audio input into a transcript of text, as shown in box 52, analyzes the transcript based on the variables selected, as shown in box 54, creates a report having feedback for the subject and sends the report; as shown in box 56, deletes the audio input and transcript, and provides access to a dashboard for comparison of various feedback.

In another embodiment, the system receives audio input and variable selection 110, processes a transcription 120, performs a variable analysis 130, and provides an output report 140. The system has a data storage device storing a set of variables, a recording device to record audio input during teaching, the audio input being uploaded to the system, a transcript created from the audio input, and an input mechanism to choose at least one variable from the set of variables. They system also has a processor to analyze the transcript in view of the chosen variables and provide an analysis a report having feedback generated from the analysis, and a communication mechanism to provide the report to the user.

In another example, Mary is a classroom teacher who wants to improve on her teaching. Mary decided she wanted to try the system to help her improve her classroom environment and make her class feel more positive. As a result, Mary decides to use the system to analyze her teaching for praise statements.

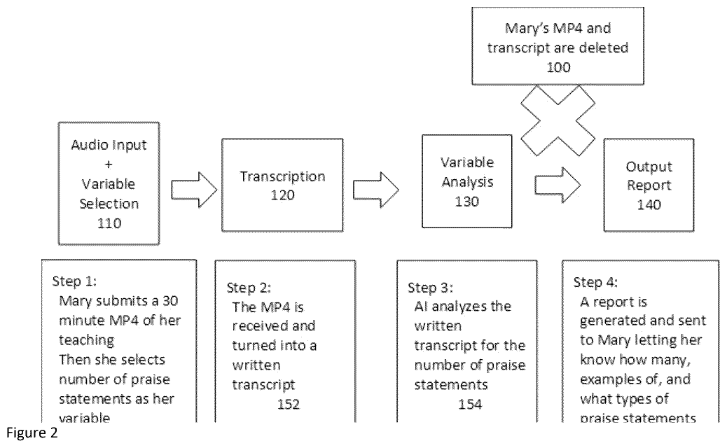

As shown in box 150, in strep 1, Mary decides to use the system and uses her cell phone to capture an audio-only 30-minute recording of herself teaching. Mary uploads this audio recording to the system and selects her variable as praise statements. Once Mary does this, the process takes full shape via the diagram in FIG. 2. As shown in box 152, in step 2, the MP4 file is received and turned into a written transcript. In step 3, artificial intelligence analyzes the written transcript for the number of praise statements, as shown in box 154. In step 4, a report is generated and sent to Mary to let her know how many, examples of, and what types of praise statements she used, as shown in box 156. Mary's MP4 and transcript are then deleted in box 100.

The invention seeks to eliminate lengthy professional evaluations with an administrator sitting in a room for one hour or more judging, recording, and observing a teacher's every move. The system provides an opportunity to receive individualized feedback on instruction without having to have a middleman. The system allows teachers to take control of their own improvement, schedule their own reflective observations or feedback cycles, and find ways to continually improve their practice.

Administrators often spend countless hours per week observing teachers. Seen as a check the box activity, principals and school leaders spend their required number of hours at their required frequency a year observing teachers, scripting teacher talk, and analyzing what they observe using antiquated rubrics.

The system may remove bias, saves time, and provides evidence-based feedback to individuals automatically. Even better, at the school, district, or institutional level, this feedback is aggregated for grade-levels, grade bands, entire schools, or even entire districts. The system is capable of using real show evaluation data to make informed decisions about learning.

In one embodiment, the system works at the individual level and has options for data analysis and reporting at the following de-identified levels for any variables, including grade-level or grade-band and whole school. The system may provide administrator access to a de-identified data dashboard that may be on any selected variable.

The system may be applied in any educational setting. The system may be used for an entire school or district professional learning sessions, during grade-level or grade band professional learning communities, and even for college or university instructors.

Although the invention has been described in detail and with reference to specific embodiments, it will be apparent to one skilled in the art that various changes and modifications can be made without departing from the spirit and scope of the invention. Thus, it is intended that the invention covers the modifications and variations of this invention provided they come within the scope of the appended claims and their equivalents.

1. A method for providing educational feedback comprising:
providing a computer-implemented system having a database of variables;
recording audio input from a subject during teaching;
receiving the audio input into a system;
selecting variables for analysis;
processing the audio input into a transcript;
analyzing the transcript based on the variables selected; and
creating a report having feedback for the subject.

2. The method of claim 1 further comprising deleting the audio input and written transcript to maintain privacy of the subject.

3. The method of claim 1 wherein the analyzing comprises:
counting the number of statements made in a certain category; and
generating data to provide the number in a readable report.

4. The method of claim 1 wherein the creating comprises:
providing a dashboard for the subject to view variable feedback and track data over time.

5. The method of claim 1 wherein the audio input is provided by a at least one of a video file and an audio file.

6. The method of claim 1 further comprising:
recording audio input from several subjects in a category;
anonymizing the subjects; and
combining the feedback from each subject into the report.

7. The method of claim 6 wherein the category comprises a grade level and the subjects comprise teachers in the same grade.

8. The method of claim 1 wherein the creating comprises:
immediately providing corrective feedback to a user; and
measuring improvement of the teaching over time.

9. A computer-implemented method of providing educational feedback comprising:
recording audio input from a subject during teaching for at least 15 minutes;
uploading the audio input into a computer-implemented system;
selecting variables for analysis;
processing the audio input into a transcript;
analyzing the transcript based on the variables selected;
creating a report having feedback for the subject;
deleting the audio input and transcript sending the report; and
providing access to a dashboard for comparison of various feedback.

10. A system for providing educational feedback to a user comprising:
a data storage device storing a set of variables;
a recording device to record audio input during teaching, the audio input being uploaded to the system;
a transcript created from the audio input;
an input mechanism to choose at least one variable from the set of variables;
a processor to analyze the transcript in view of the chosen variables and provide an analysis;
a report having feedback generated from the analysis; and
a communication mechanism to provide the report to the user.

11. The system of claim 10 wherein the system comprises at least one of a handheld device, a computer, a tablet, and a cloud-based system.

12. The system of claim 10 wherein the recording device comprises at least one of a handheld device, a video recorder, an audio recorder, and a computer.

13. The system of claim 10 wherein the communication mechanism comprises an e-mail, a printed document, and a dashboard.

14. The system of claim 10 wherein the set of variable comprises at least one of a number of questions, number of statements, number of yes and no responses, number of non-verbal responses, number of verbal responses, number of times a word is used, number of praises, number of criticisms, number of opportunities to respond, number of choices offered with a task, number of responses during a period of time, and number of words during a period of time.

15. The system of claim 10 wherein the feedback comprises corrective feedback for the user to improve the audio input.

16. The system of claim 10 wherein the user comprises at least one of a teacher and an academic institution.
